(19) United States
(12) Patent Application Publication
(10) Pub. No.: US 2006/0225084 A1
(43) Pub. Date: Oct. 5, 2006

(54) Partition selection for universal storage device

(76) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/553,719

(22) PCT Filed: Apr. 22, 2004
(86) PCT No.: PCT/IB04/50481

§ 371 Date: Oct. 18, 2005

(30) Foreign Application Priority Data
Apr. 23, 2003 (EP) 03101114.1

(51) Int. Cl. G11B 33/02; G06F 12/00

(52) U.S. Cl. 720/600; 711/115

(57) ABSTRACT

The present invention relates to a drive device and method of reading from or writing to a record carrier (10), wherein a predetermined portion of the maximum storage capacity of said record carrier (10) is exposed via an access interface function of a drive device (30). At least one of a size and a location of the predetermined portion is selectable by an input function at the interface function. Thereby, legacy host devices which cannot use the full storage capacity of advanced drive devices (30) can take full or better advantage of the total storage capacity.

The present invention relates to a storage device and method of reading from or writing to a recording medium, such as a Flash card or an optical disc. In particular, the invention relates to partition selection at a standard drive interface for an optical disc.

The applicant has recently developed a miniature optical disc that records, plays back and erases data using the same precision blue lasers that are being developed for the next generation of high-definition disc based video recorders. A system of the miniature optical disc is known as SFFO (Small Form Factor Optical) or Portable Blue (PB) and shows that it is possible to store 4 Gigabytes on a 3-cm-disc, and to make a drive device that can read it reliably as small as a memory card. The PB disc will have a well-defined logical format according to a standard file system, such as UDF (Universal Disk Format) as specified in the UDF specification Revision 2.01 by Optical Storage Technology Association (OSTA) dated Apr. 3, 1998 or a later version. However, host devices or data sources may not understand this format and so they may write data in a way that is not compliant to the PB disc format.

Currently, there are a number of standard interfaces for connecting storage devices to hosts such as personal computers (PCs), mobile phones or digital cameras. Possible interfaces include PCMCIA (Personal Computer Memory Card International Association), Compact Flash, MMCA (Multi Media Card Association), Newcard etc. It is possible to use different storage technologies in conjunction with the same interface, for example, the hard-disk based Microdrive has a Compact Flash (CF) interface. These standard interfaces provide physical compatibility but the logical format on the device, most notably the file system, is not covered by the standard. Therefore, although the host may be able to interface with the storage device, there is no guarantee that it can understand the way data is stored on the storage device. The storage device presents itself to the host as a logical address space.

Furthermore, there are many devices that allow the insertion of CF-II cards to be used for storage. The most well known CF-II storage cards are Flash cards, i.e. cards based on non-volatile RAM (Random Access Memory) technology. Host devices include digital cameras and PDAs (Personal Digital Assistants). Legacy hosts support a limited address range and can therefore not address the top address range of a high capacity storage solution. Thus, many current host devices only support a limited capacity range for storage. Some older devices accept only 8 MB cards, while new devices support up to 512 MB. The first proposed CF-II compatible PB drive has a capacity of 1 GB and next generations will support 2 GB and 4 GB within the next few years. In general, only resource rich hosts like PCs do not suffer from the limitation in the addressable storage capacity of inserted storage cards, because their access functionality is more flexible.

Hence, many of the current host devices cannot use the full storage capacity of PB discs nor of next generation Flash cards. This means that either these devices cannot use the higher capacity storage solutions, or they can only use a limited portion of the available storage capacity. In the end, if the smaller sized cards are less prevalent, they will become more expensive or even disappear from the market as it is no longer profitable to offer them.

It is therefore an object of the present invention to provide a method and drive device for enabling the use of the full storage capacity of high capacity storage devices by host devices supporting only limited address range for storage.

This object is achieved by a drive device as claimed in claim 1 and by a reading or writing method as claimed in claim 16.

Accordingly, a mechanism is provided to select a portion of the storage capacity to be exposed across the interface of the drive device. Thereby, legacy host devices with limited address range can take full or at least better advantage of the total storage capacity of advanced or next generation storage devices. Furthermore, storage on the same recording medium for different host devices can be separated conveniently and completely.

In connection with the present invention, the term “legacy” is used to indicate those formats, applications, data or devices, which have been inherited from languages, platforms, and techniques earlier than the current technology. Typically, the challenge is to keep the legacy features or applications running or legacy devices supported while converting it to newer, more efficient features or devices that make use of new technology and skills.

The selecting means may comprise switching means for switching between at least two selection states for selecting at least one of a location and a size of said predetermined portion. In particular, the switching means may comprise at least a first switching means for switching between at least two different locations and a second switching means for switching between at least two different sizes. Thereby, location and/or size of different exposable smaller portions can be selected. Moreover, the second switching means can be used to select a sectioned exposure of the maximum storage capacity, while the first switching means can be used to select among the exposed sections.

The switching means may comprise a software switch operated by a selection input signal receivable via an input terminal of the storage device. In this case, a selection of the partitioning can be effected by master host device which is aware of the selection functionality. As an alternative or an additional measure, the switching means may comprise a hardware switch arranged on the storage device. Then, the hardware switch can be used in isolation and operated by a user.

As a specific example, the switching means may provide a first selection type defining a first selection state in which the predetermined portion correspond to the maximum storage capacity, a second selection state in which the predetermined portion corresponds to the second half of the maximum storage capacity, a third selection state in which the predetermined portion corresponds to the second quarter of the maximum storage capacity, and a fourth selection state in which said predetermined portion corresponds to the fourth quarter of the maximum storage capacity.

According to another specific example, the switching means provide an alternative or additional second selection type defining a first selection state in which the predetermined portion correspond to the first quarter of the maximum storage capacity, a second selection state in which the predetermined portion corresponds to the second quarter of the maximum storage capacity, a third selection state in which the predetermined portion corresponds to the third quarter of the maximum storage capacity, and a fourth selection state in which the predetermined portion corresponds to the fourth quarter of the maximum storage capacity.

Of course, other selection types with arbitrary partitioning and overlapping portions which may have different sizes and/or only partial coverage of the maximum storage capacity may be provided.

Furthermore, each selection state can be allocated to a different specific host device to which the storage device is connectable.

The switching means may be programmable by a programming signal receivable via an input terminal of the storage device.

Moreover, the configuration of the selecting means may be stored on the recording medium. In case the recording medium is an optical disc, the configuration can be stored in a drive navigation area of the optical disc. And, the storage device may be a removable drive device for an optical disc.

The interface means may be a standard interface for storage devices, such as a PCMCIA, Compact Flash, Newcard or MMCA interface.

Furthermore, the file system area of the full format of the recording medium, e.g. the PB format, may be excluded from the exposed predetermined portion. Thereby, the UDF file system used by modern hosts can be protected from accidental damage by legacy hosts.

Further advantageous modifications are defined in the dependent claims.

The present invention will now be described on the basis of preferred embodiments with reference to the accompanying drawings, in which:

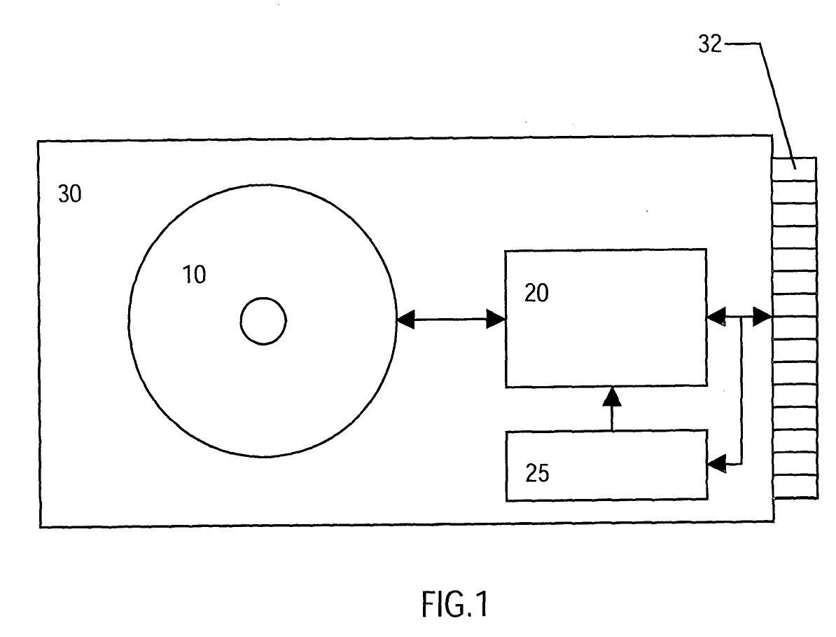

FIG. 1 shows a schematic block diagram of a removable drive device with a standard interface and input function according to the preferred embodiments of the present invention;

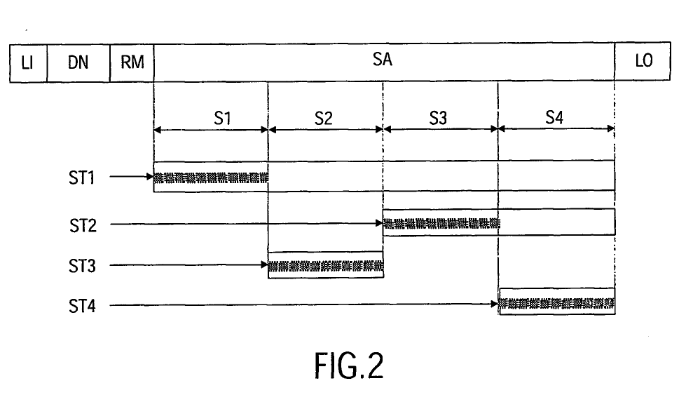

FIG. 2 shows a schematic diagram of a logical format of an optical disk with a selectable partitioning according to a first preferred embodiment;

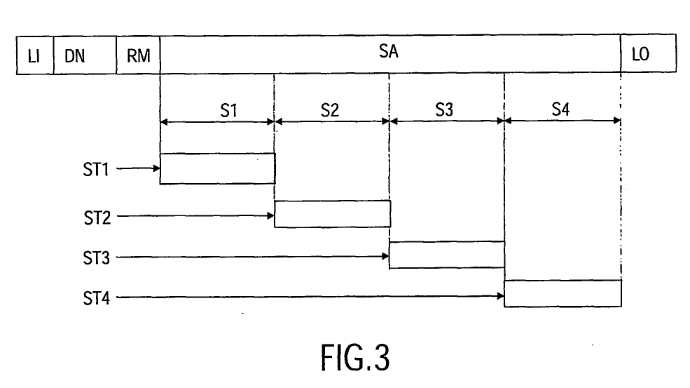

FIG. 3 shows a schematic diagram of a logical format of an optical disk with a selectable partitioning according to a second preferred embodiment; and

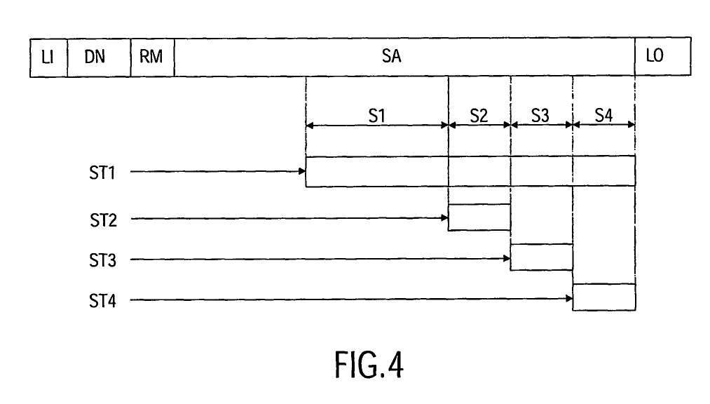

FIG. 4 shows a schematic diagram of a logical format of an optical disk with a selectable partitioning according to a third preferred embodiment.

The preferred embodiments will now be described in connection with a removable PB drive device which exposes a FAT based CF-II interface to legacy hosts such as a digital camera, a PDA or the like.

A storage device needs a file system so that the data can be stored and retrieved as files. The most common file system for CD-ROM is ISO 9660 which is the international standard version of the High Sierra Group file system and is designed for personal computers.

With the advent of the Digital Versatile Disc (DVD), the UDF file system has been added to the list. This is suitable for read-only, re-writable (RW) and recordable or write-once (R) discs and allows long file names, as for instance, the Joliett extension to ISO 9660. CD media require special consideration due to their nature. CD was originally designed for read-only applications which affects the way in which it is written. RW formatting consists of writing a lead-in, user data area, and lead-out. These areas may be written in any order. The physical format may be followed by a verification pass. Defects found during the verification pass are enumerated in a non-allocatable space list. Free space descriptors can be recorded and reflect space allocated to defective areas and sector sparing areas. The format may include all available space on the medium. However, if requested by the user, a subset may be formatted to save formatting time. That smaller format may be later grown to the full available space.

Until recently, optical discs have not been used intensively as true random access devices. With the introduction of transparent defect management and speed-up of read and write cycles for optical discs, this type of use is expected to intensify. Multiple portable device types, e.g. video cameras or mobile phones, are expected to have PB drive devices as primary storage.

In the following preferred embodiments, UDF is used as the PB file system.

FIG. 1 shows a removable drive device 30 adapted e.g. to fit the Compact Flash form factor. Hence, the drive device 30 can be used to replace solid state memories. To achieve this, a standard CF-II interface unit 20 with corresponding connection terminals 32 is provided. Due to the fact that the CF interface unit 20 is commonly used in connection with a FAT file system, it must be arranged to map from FAT to UDF when writing to the disc 10 of the removable drive device 30, and to map from UDF to FAT when reading from the disc 10. In this respect, it is noted that the disc navigation area DN provides means to circumvent UDF, i.e. the exposed partition may not be visible from UDF, in which case there is no need for mappings.

FAT is the MS-DOS file system supported by most of today's operating systems. It comes in three different types, i.e. FAT 12, FAT 16 and FAT 32, wherein the names refer to the number of bits used by the entries in the file allocation table which gave the file system its name. The file allocation table is actually one of the structures inside the FAT file system as seen on-disc. The purpose of this table is to keep track of which areas of the disc are available and which areas are in use. In FAT, the data area is divided into clusters which correspond to groups of sectors on the FAT media. The rest of the partition is simply divided into sectors. Files and directories store their data in these clusters. The size of one cluster is specified in a structure called the Boot Record and can range from a single sector to 128 sectors. The Boot Record is located within an area of reserved sectors. The actual file allocation table structure is a relatively simple structure. It is simply an array of 12-bit, 16-bit or 32-bit data elements.

The file allocation table can be regarded as a singly linked list. Each of the chains in the file allocation table specifies which parts of the disc belong to a given file or directory. The user data area is the area where the contents of the files and directories are stored.

According to the preferred embodiments, an input or selection function 25 is provided at the removable drive device 30 to select a portion of the maximum storage capacity of the disc 10 to be exposed across the interface unit 20. Thereby, legacy host devices can take full or better advantage of the total storage capacity provided by the PB drive device 30. In particular, the drive device 30 can be used more optimally by legacy host devices. In particular, the selection function 25 provides control information to the interface unit 20 so as to expose a selected portion of the total storage capacity of the optical disc 10 to the host device connected via the connecting terminals 32. Thereby, storage portions on the same disc 10 can be separated conveniently and completely, e.g. for different host devices.

The selection function 25 may be controlled by a switch, e.g. a soft switch and/or a hardware switch. The soft switch means that the switch cannot be operated in isolation. In this case, a master host is needed which is aware of the soft switching function and which can operate it, e.g. based on a input control signal supplied via at least one of the connection terminals 32. On the other hand, the alternative or additional hardware switch may be provided in the exterior of the drive device 30. The hardware switch can be used in isolation and operated by the user. The hardware switch may be programmable by a programming signal supplied to the selection function 25 e.g. via the connection terminals 32.

FIGS. 2 to 4 show different volume structures or lay-outs of a logical format of an information area arranged on the spiral track provided on the optical disk 10, according to the first, second and third preferred embodiments of the present invention.

The information area provided on the optical disc 10 consists of lead-in LI, user data storage area SA, and lead-out LO. The lead-in LI includes a disc navigation area DN and a rights management area RM. It may also include a defect management area (not shown). The storage area SA includes areas for the location of volatile files, start-up files and file system meta data The disc navigation area DN is a space reserved for pointers and application specific data. Additionally, the disc navigation area DN can be used for reserving space in the program area for specific file systems, allocation classes or applications, for assigning properties or attributes to the reserved space, and/or for providing pointers in the reserved space and room for application specific data. For certified allocation classes, specific areas can be reserved in the program area. These classes may comprise volatile files which are files of a certain size that are written often. In the preferred embodiments, the configuration of the selection or switching states at the selection function 25 and the resulting partitioning can be stored in the disc navigation area DN or any other suitable disc management area.

FIG. 2 shows a lay-out of the logical format with a selectable partitioning according to the first preferred embodiment. The selection function 25 is adapted to provide a selection between four different accessible storage portions of different size and/or location generated from four sections S1 to S4 corresponding to the first to fourth quarter of the total storage capacity of the storage area SA on the disc 10. The selected storage portion is then exposed via the interface unit 20 towards the connected host device. Thus, the soft or hardware switch may have four corresponding switching states for selecting one of the selectable storage portions.

In the first preferred embodiment, a type I selection is specified, which may be a default selection type to which the drive device 30 is reset after initial power supply. According to this type I selection, the first state ST1 exposes all of the total storage capacity to the connected host device. The second state ST2 exposes the second half the total storage capacity, the third state ST3 exposes the second quarter of the total storage capacity, and the fourth state ST4 exposes the fourth quarter of the total storage capacity, as depicted in FIG. 2. Thus, in case a host device supports only a limited storage capacity, the selection function 25 can be controlled in such a manner that only a part of the available storage capacity is used or offered. This is depicted by the grey bars in FIG. 2. In case of a 1 GB PB disc 10, this would correspond to 256 MB storage space offered to and used by the connected host device. Without the selection function 25, the remainder of the total storage capacity would be unavailable to that particular host. With the selection of the second state ST2, only the second half of the total storage capacity will be exposed across the interface unit 20. Again, only 256 MB of this 512 MB can be utilized by this particular host, as depicted by the grey bar. Similarly, the third state ST3 exposes the second 256 MB, and the fourth state ST4 exposes the fourth 256 MB, such that the host device is enabled to access the whole 1 GB storage capacity. If the host device can handle a storage capacity of 512 MB, then the third and fourth states ST3, ST4 would not be needed for a 1 GB PB disc. In this case, the behaviour of the third and fourth states may be programmed to correspond to the second state ST2.

FIG. 3 shows a lay-out of the logical format with a selectable partitioning according to the second preferred embodiment. Again, the selection function 25 is adapted to provide a selection between four different accessible storage portions of a different location generated from the four sections S1 to S4 corresponding to the first to fourth quarter of the total storage capacity of the storage area SA on the disc 10.

In the second preferred embodiment, a type II selection is specified, wherein the first state ST1 offers the first quarter of the total storage capacity to the connected host device. The second state ST2 offers the second quarter of the total storage capacity, the third state ST3 offers the third quarter of the total storage capacity, and the fourth state ST4 offers the fourth quarter of the total storage capacity, as depicted in FIG. 3. Thus, the selection states of the selection function 25 are configured such that each state offers a quarter of the total storage capacity. E.g., for a 4 GB disc 10, this means 1 GB per section.

FIG. 4 shows a lay-out of the logical format with a selectable arbitrary partitioning according to the third preferred embodiment. Again, the selection function 25 is adapted to provide a selection between four different accessible storage portions of different location and size generated from four sections S1 to S4 which however cover only a portion of the total storage capacity of the storage area SA on the disc 10. Thus, not all storage capacity is exposed through the interface unit 20. Furthermore, the partitions are not equal in size and some may overlap. It is even possible, to let each state expose the total storage capacity, thereby effectively rendering the selection function 25 inactive. The sizes and/or locations of the accessible or offered storage portions arbitrary partitioning can be programmed by a corresponding programming input provided at the selection function 25. It is thus possible, to reserve each state for a different specific host device and tailor each section to that host. It can be advantageous to exclude the file system area of the full PB format from the total area exposed to legacy hosts, thereby effectively protecting the UDF file system used by modern hosts from accidental damage by legacy hosts.

The functions provided by the selection unit 25 and by the interface unit 20 may be implemented as discrete hardware elements or as software routines controlling a processing element, such as a signal processor or a micro processor, which form or belong to a control unit or controller of the drive device 30. Furthermore, other types of partitioning the total storage capacity can be offered, while more or less than the four selecting states ST1 to ST4 can be used. In case of more selection states, smaller portions of the total storage capacity can be exposed at a time. Moreover, more than one switch can be used to control the selection function 25. Then, a first switch may be used to determine the size, e.g. whether there is a sectioned exposure or not, while a second switch may be used to select the location, e.g. which of the sections is to be exposed. Furthermore, the selectable states may be non-contiguous parts of the offered total storage space. The partitioning can be hard or virtual, wherein hard partitioning refers to explicitly defined boundaries of partitions, while virtual partitioning refers to implicit partitions which are not defined explicitly, i.e. shape, boarders and size of these data sub-regions are not prescribed but can change dynamically, which leaves the choice for implementations to fit the intended purpose.

Further details concerning the virtual or implicit partitioning can be gathered e.g. from document WO 01/95331 A2. Defect management can be performed for each partition separately.

It is noted that the present application is not restricted to the above specific embodiments but can be used in any storage device having an interface unit through which a host device can be connected. In particular, the storage device can be a Flash card or a Microdrive. The preferred embodiments may thus vary within the scope of the attached claims.

1. A storage device for providing access to a recording medium (10), said storage device (30) comprising:
a) interface means (32) for exposing a predetermined portion of the maximum storage capacity of said recording medium (10), said predetermined portion being addressable for inputting or outputting data across said interface means (32); and
b) selecting means (25) for selecting said predetermined portion in response to a selection input.

2. A device according to claim 1, wherein said selecting means comprises switching means (25) for switching between at least two selection states for selecting at least one of a location and a size of said predetermined portion.

3. A device according to claim 2, wherein said switching means comprises at least a first switching means for switching between at least two different locations and a second switching means for switching between at least two different sizes.

4. A device according to claim 2, wherein said switching means comprises a software switch operated by a selection input signal receivable via an input terminal (32) of said storage device (30).

5. A device according to claim 2, wherein said switching means comprises a hardware switch arranged on said storage device (30).

6. A device according to claim 2, wherein said switching means provides a first selection type defining a first selection state in which said predetermined portion correspond to said maximum storage capacity, a second selection state in which said predetermined portion corresponds to the second half of said maximum storage capacity, a third selection state in which said predetermined portion corresponds to the second quarter of said maximum storage capacity, and a fourth selection state in which said predetermined portion corresponds to the fourth quarter of said maximum storage capacity.

7. A device according to claim 2, wherein said switching means provides a second selection type defining a first selection state in which said predetermined portion correspond to the first quarter of said maximum storage capacity, a second selection state in which said predetermined portion corresponds to the second quarter of said maximum storage capacity, a third selection state in which said predetermined portion corresponds to the third quarter of said maximum storage capacity, and a fourth selection state in which said predetermined portion corresponds to the fourth quarter of said maximum storage capacity.

8. A device according to claim 2, wherein each selection state can be allocated to a different specific host device to which said storage device (30) is connectable.

9. A device according to claim 2, wherein said switching means is programmable by a programming signal receivable via an input terminal (32) of said storage device (30).

10. A device according to claim 1, wherein a configuration of said selecting means (25) is stored on said recording medium (10).

11. A device according to claim 10, wherein said recording medium is an optical disc (10) and said configuration is stored in a drive navigation area (DN) of said optical disc (10).

12. A device according to claim 1, wherein said storage device is a removable drive device (30) for an optical disc (10).

13. A device according to claim 1, wherein said interface means is a standard interface (32) for storage devices.

14. A device according to claim 13, wherein said standard interface (32) is a PCMCIA, Compact Flash, Newcard, or MMCA interface.

15. A device according to claim 1, wherein a file system area of said recording medium (10) is excluded from said exposed predetermined portion.

16. A method of reading from or writing to a recording medium (10), said method comprising the steps of:
a) providing an access interface function (20) for reading from or writing to said recording medium (10);
b) exposing via said access interface function (20) a predetermined portion of the maximum storage capacity of said recording medium (10); and
c) providing an input function (25) for selecting at said access interface function at least one of a size and a location of said predetermined portion.
